(19) United States
(12) Patent Application Publication
(10) Pub. No.: US 2006/0085373 A1
(43) Pub. Date: Apr. 20, 2006

(54) Method and apparatus for creating relationships over a network

(76) Inventors: Jasjit S. Dhillion, Rancho Palos Verdes, CA (US); Mark Damian Jeffrey, Santa Monica, CA (US); Todd Kamin, Atlanta, GA (US); Frederick Sidney Conklin, Orinda, CA (US); Peter Stewart Hutto, South Pasadena, CA (US); Stanley Bruce Crair, San Marino, CA (US)

Correspondence Address: KENYON & KENYON LLP, 1500 K STREET N.W., SUITE 700, WASHINGTON, DC, 20005, US

(21) Appl. No.: 10/956,489

(22) Filed: Sep. 30, 2004

(51) Int. Cl. G06F 17/30

(52) U.S. Cl. 707/1

(57) ABSTRACT

Embodiments of the present invention include an information sharing system that provides an online business service from a provider that uses the Internet to enable individuals and organizations to link together contact databases that reside in multiple desktop applications and create a unified meta-database. This database can be searched by individual subscribers in order to locate a specific entity (such as an organization or a person, by name, title or organization, such as an executive in a target organization), identify if a path to the executive exists through a chain of contacts across the linked contact databases, and request a referral based introduction to the specific executive.

### RELATED APPLICATIONS

The present application claims priority to U.S. patent application Ser. No. 10/902,078 filed on Jul. 30, 2004, entitled “Method and Apparatus for Sharing Information over a Network” (attorney docket number 13053/3), the disclosure of which is incorporated herein in its entirety.

### BACKGROUND OF THE INVENTION

The present invention pertains to a method and apparatus for creating relationships over a network such as the Internet. More particularly, the present invention pertains to the creation and use of a person-to-person network of individuals. For example, through such a network, a first subscriber may obtain an introduction to or referral to a “contact” (e.g., a person, corporation, etc.) which is maintained in the database of a second subscriber.

A personal network is a valuable and underutilized asset. Building personal connections in business, professional and social life is a lifelong process. The foundation of this network is based on trusted relationships. Current methods of expanding and keeping an individual trust network are slow, time consuming and require great personal effort. As is well-known, the most successful people have personal trust networks with exceptional depth and strength that integrate lifetime business and personal relationships into a seamless whole. Business and personal success depends greatly upon the ability to enhance the depth, strength and span of trust networks.

In today's world of information overload it is difficult to rise above the noise of the competition, identify the right economic decision makers and have the opportunity to meet with them in timely manner. Traditional sales and marketing methods and processes are costly and do not provide any guarantee that a message has reached the right person. Personal trust networks are a much more effective method of getting to the right person in time, with relevance. A methodology and technology for rapidly enhancing the depth, strength, and span of a trust network is needed to solve this obvious predicament.

An existing personal trust network has tremendous untapped potential. Accordingly, there is a need to improve the effectiveness of a personal trust network.

### SUMMARY OF THE INVENTION

Embodiments of the present invention include an information sharing system that provides an online business service from a provider that uses the Internet to enable individuals and organizations to link together contact databases that reside in multiple desktop applications and create a unified meta-database. This database can be searched by individual subscribers in order to locate a specific entity (such as an organization or a person, by name, title or organization, such as an executive in a target organization), identify if a path to the executive exists through a chain of contacts across the linked contact databases, and request a referral-based introduction to the specific executive.

### BRIEF DESCRIPTION OF THE DRAWINGS

FIG. 1 is a block diagram of a system for creating a person-to-person network according to an embodiment of the present invention.

FIG. 2 is an example of a display showing contact candidates and corresponding weight values.

FIGS. 3a-c are flow diagrams of a method for creating and searching an index for contacts in the network system according to an embodiment of the present invention.

FIG. 4 is a screen display showing an example of the results of the method of FIGS. 3a-c.

FIGS. 5a-d are flow diagrams of a method for creating/removing a high trust level relationship and for displaying contacts of a high trust level member according to an embodiment of the present invention.

FIGS. 6-9 are screen displays showing an example of the results of the method of FIGS. 5a-d.

FIGS. 10-11 are examples of electronic mail messages generated during embodiments of the present invention.

FIG. 12 is a flow diagram for allowing a third party user to introduce two friends according to an embodiment of the present invention.

FIGS. 13-14 are screen displays showing an example of the procedure of FIG. 12.

FIGS. 15a-b are block diagrams for unifying member and contact search results according to an embodiment of the present invention.

FIG. 16 is a screen display of the results from FIGS. 15a-b.

FIGS. 17a-d are examples of the process of searching for data objects associated with people and people associated with data objects according to an embodiment of the present invention.

FIG. 18 is a screen display of the results from FIGS. 17a-d.

### DETAILED DESCRIPTION

Embodiments of the present invention are based on the concept of selective sharing of trust networks. A subscriber to the present system has the ability to expand a network immediately by sharing it with the subscriber's closest associates, friends and confidants. In turn, they are encouraged to share their trust networks with the subscriber. This process can enable the subscriber to almost exponentially increase the depth, strength and span of a trust network over a relatively short time frame.

According to an embodiment of the present invention, a person-to-person network is created that allows a first subscriber to obtain a referral from or introduction to “contacts” of a second subscriber. This network is a secure, online solution that makes the selective sharing of trust networks a reality.

To become a subscriber to the system according to an embodiment of the present invention, there are two options. The first option is to be invited by an already-existing subscriber. That option allows the potential subscriber to have access (as a subscriber) to the trust network established by the already-existing subscriber. The second option is for a potential subscriber to contact the service provider (such as by going to the provider's web site) and creating a trust network, to which the potential subscriber invites close associates and confidants to also become subscribers. In furtherance of this second option, once the potential subscriber has been approved by the service provider, the potential subscriber is provided with an unique, secure ID that is used to access the service. At this point, the potential subscriber decides which contacts and which information from the potential subscriber's personal computer contact database will be included in the secure online network. Once the potential subscriber has been provided with the secure ID (thus becoming a subscriber) and has created an online trust network, other members of this trust network who are identified in the subscriber's contact database can be invited to join the system as subscribers and share their respective contact databases with the first named subscriber. The network provider supplies the technology to conduct searches across expanded trust networks while maintaining complete confidentiality of the names and contact information of the search target. The trust network members (subscribers) can also conduct searches across the network of people listed in the database and the system provides for an automated maintenance of changes of contact information within the trust network.

Features of the system described herein include the following:

Searches: The information sharing system includes a number of search processes and search result presentation styles. A subscriber can search for a target executive or organization from within Microsoft® Outlook by entering the search criteria in an information sharing system search box. Searches can also be conducted in the information sharing system's web application. For example, the search process allows for a search to be initiated from a desktop application through a series of networked (e.g. Internet) based contact databases and presents the results back to the subscriber inside the desktop applications. Search results are presented in a number of different formats. Subscribers can then request introductions to their targets directly from within the search result window. Searches include the following:

General Search: First subscriber John Doe Confidential (Target). The subscriber can then request John Doe to provide an introduction to the target.

Inner Circle Search: First Subscriber John Doe to James Smith, Manager, Target Company. The first subscriber can then request an introduction to Mr. Smith from Mr. Doe. If the First Subscriber and Mr. Doe are members of each other's Inner Circle, there is an explicit advance agreement to allow each other access to the detailed contact information of the contacts in the system contact database.

Confidential Squared Search: First Subscriber→Confidential→Confidential (Target Company). This search indicates that there is someone in the subscriber's own network who can make an introduction to the Target Company, but they want to keep their name private. The First Subscriber can still send the person under the Confidential label an introduction request and get a reply.

The inner circle concept allows subscribers to take their relationship to a higher level of trust by enabling them to selectively invite other subscribers to not only search across their contact database but also browse in real time and view detailed contact information on the contacts in their individual databases.

Concept of Groups: A subscriber may set up a group of contacts that is a sub-set of the subscriber's entire contact database. The subscriber can then provide selective access to the subscriber's contact database by limiting the access of other subscribers to specific groups. This is especially useful in the case where a Senior Executive may want to open up parts of a network database selectively e.g. groups by Account, by project etc.

Concept of Third Party Introductions: Third party introductions may be provided in the networked contact database world. In many situations, an individual may not need introductions to anyone, but might happen to already know two individuals they think should meet. Where an individual already relates to two individuals, they can request those two individuals should meet.

Another feature of the present system is referred to as subscriber agent/affinity matching. One of the biggest challenges in social networks is to match individuals based on fuzzy profiles and interests. The present system provides the use of Semantic Agents that perform the following tasks:

Profiling and Intelligent Matching of People: Embodiments of the present invention create profiles of members based on their personal and business information and the connections they are making in the system. The system can then use these rich profiles to create recommendations for introductions between subscribers or contacts who may be working on similar projects, facing similar personal challenges, experiencing similar life transitions, etc. The system can connect members with people they should know based on shared values, vision, goals, etc., and can make the auto-matching of individuals across wide-area networks a reality.

Another feature of embodiments of the present system is referred to as unifying member and contact search results. One of the biggest problems in a relational network that incorporates contacts who are not members of the system, is the redundancy of some contacts. Frequently multiple members may have contacts in their respective contact lists that refer to the same individual. Without becoming a member, that contact may exist as multiple entries, and hence searches for that person would result in multiple hits even though they exist as one person or entity. The present system pioneers the use of super-indexing in order to recognize and represent multiple contacts as a single entity. Examples of this super-indexing system include the following features:

Creation of a Meta-Database: Embodiments of the present system can examine all the members and contact information in the system. By examining unique identifiers such as a common e-mail address, cell phone number, or Instant Messaging identifier, the system can create a super-index of all intersecting records. The system can then use this index to refresh the meta-database with all the intersecting records and paths.

Presentation of Search Results: By resorting to the meta-database, the system can, upon the finding of duplicate contact records of the same individual, present that contact as a single result. When the user selects that single result, the system can expand the results and show all the paths to that individual.

Backward Links: When two members relate to the same member, they have a direct relation to one another. However, as some contacts are not members of the system, if two members relate to the same contact, they would not have a direct relation. Through the use of the meta-database which unifies the search results for the same contact, members can establish a direct relation to one another, if each relates to a contact ascertained to be the same individual. Thus, through the use of the meta-database and backward linking, a member can greatly increase their trusted paths to referrals.

Another feature of the system is referred to as cross-indexing traditional search engines with social networks. While most relational networks restrict themselves to only connections between people, embodiments of the present system tap a wealth of knowledge that may be associated with people. Not only does a person have contact information pertaining to them, such as telephone numbers, instant messaging identifiers, email addresses, but they also may have other information pertaining to them. This information may range from things such as group affiliations to web pages to job postings to book reviews. Embodiments of the present system can combine direct information provided by the actual user and inferred information found from searching for the user in other databases and networks such as the Internet. As such, this system offers two aspects:

Viewing People Through Information: By integrating information about people into the relational network, users may have an increased number of paths to referrals. For example, though one member has no relation to another member in the network, both individuals may belong to the same organization or social club. By exploiting this connection through personal information, individuals can relate themselves to others without a direct personal connection. Similar to how members have weighted relations, information will be weighted to its associated member or contact. The strength of the connection could be the function of the timestamp of the information, or any other appropriate weighing means.

Viewing Information Through People: Associating information with people also facilitates finding specific information. For example, a member might be looking for a job. If another member, to whom the first member relates, works at the company offering the job, or even is the actual poster of the classified ad, then by connecting the first member to the second, the first member establishes a connection to increase their chances of securing the job. Similarly, a company might be searching the applicant pool for a prospect hiree, and upon searching for prospects, find a web page or resume document associated with a prospect hiree. In another example, one member might be looking for a review of a hotel and find a posting by a friend in the network. By incorporating information into the relational network, users gain a network of trusted information.

Embodiments of the present invention will be described with reference to a network system. In one embodiment, the network system is the Internet, but the present invention can be extended to other types of network systems including local area networks (LANs), wide area networks (WANs), Intranets, etc.

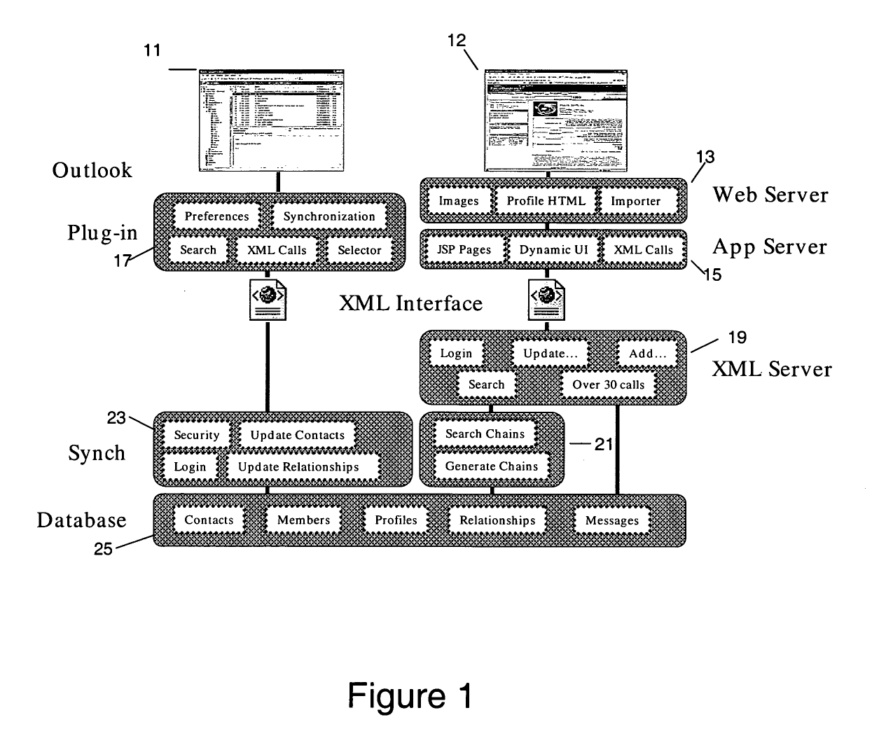

Referring to FIG. 1, a block diagram of a network including a system of the present invention is shown. In the network system, a plurality of user computer systems may be provided such as user computer 11 and 12. In this figure, the user computers 11 and 12 are general purpose personal computers including one or more processors to execute instruction code stored in a storage media such as a hard-disk drive, Compact Disc—Read Only Memory (CD-ROM), or the like. One skilled in the art will appreciate that the present invention can be expanded to a variety of other computer systems (e.g., those operating over a local network) or electronic communication systems (e.g. two-way pagers, hand-held devices, etc.). In this embodiment, each user computer 11 is capable of running a program such as the Microsoft® Outlook program (sometimes referred to as a personal information manager or “PIM” as well as a personal CRM or PCRM).

Referring to FIG. 1, the user computer 11 includes a plug-in component 17 allowing it to effectively interface with a network system such as the Internet. This is shown in FIG. 1 as an XML interface. A server system is also provided coupled to the network. In this example, the server system includes a synchronization component 23 to provide login and security operations. The synch component also can be used to update contact and relationships as described below. A database 25 is provided that stores various information concerning the users and their contacts and relationships. A search component 21 is provided that may be used to search the information stored in database 25. An XML server component 19 may also be provided to provide an XML interface between a network and the server system.

In this example, user computer 12 is coupled to the network via a web server 13 and an application server 15. As can be seen from FIG. 1, user computer 11 communicates with the server system through its Personal Information Manager (e.g., Outlook) that has been modified by the plug-in component 17 to allow the user to search and retrieve information directly in the PIM—without having to open up other applications. User computer 12 provides an alternative manner for accessing the server system (i.e., through any of a variety of known web browsers).

Initially, to create a database of contacts for a user, automated analysis of the user's E-mails may be performed to order them in relative importance to the user and extract contact information. Collected addresses can be weighted based on relevance. For example, the weighting can be performed based on frequency of occurrences and total number of occurrences.

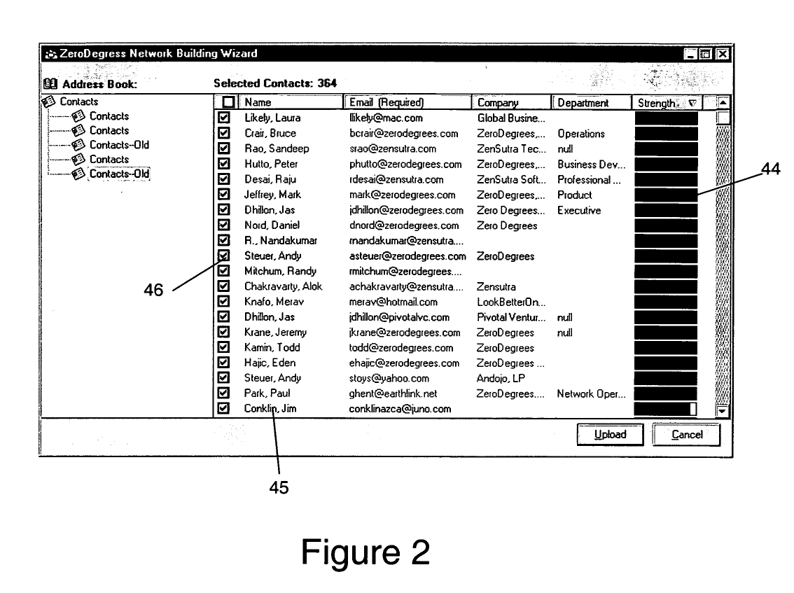

At least a portion of the contact information and the corresponding weight values are displayed to the user. For example, a user input can cause the program to access the contact/weight information and display it to the user. An example of such a display is shown in FIG. 2. In FIG. 2, the potential contacts 45 are shown with the corresponding weight values 44. The user may be provided with a check box 46 to select which contacts to include for his/her personal network of contacts. Using the method and system described above, a subscriber is able to identify and collect a group of contacts for use in the person-to-person network. Much of this can be done automatically, distilling what may be tens of thousands of contacts quickly and efficiently.

Once the user has identified a collection of contacts, the system is able to automatically generate a networked contact management system. In this embodiment, the system is able to:
1. update the network database of the server system with new contact information;
2. identify those contacts who are already members of the network and alert them to the introduction of the user to the network; and
3. initiate a dialog with the other contacts to increase the number of members in the network.

The user may be provided with a web-based contact management system that is accessible through any web device.

Once a contact database has been created for a user, a subscriber may invite any one of the contacts to join the system. When one of the contacts does accept the invitation and joins the system, the system, preferably under control of the provider, automatically synchronizes the contact's latest contact information with the existing record in the user's contact manager at his/her computer. This can be done automatically or on pre-defined intervals.

Once a user has created his/her contact database, the resulting network database of contacts may be searched in a variety of ways. For example, the system of the present invention may include a number of search processes and search result presentation styles. A subscriber to the network system may search for a target executive or organization from within a contact organization program such as Microsoft® Outlook by entering the search criteria in the information sharing system search box. Searches may also be conducted in the information sharing system's web application. In summary, the search process allows for a search to be initiated from a desktop application through a series of networked (e.g., Internet) based contact databases and presents the results back to the subscriber inside the desktop applications. Search results are presented in a number of different formats. Subscribers can then request introductions to their targets directly from within the search result window.

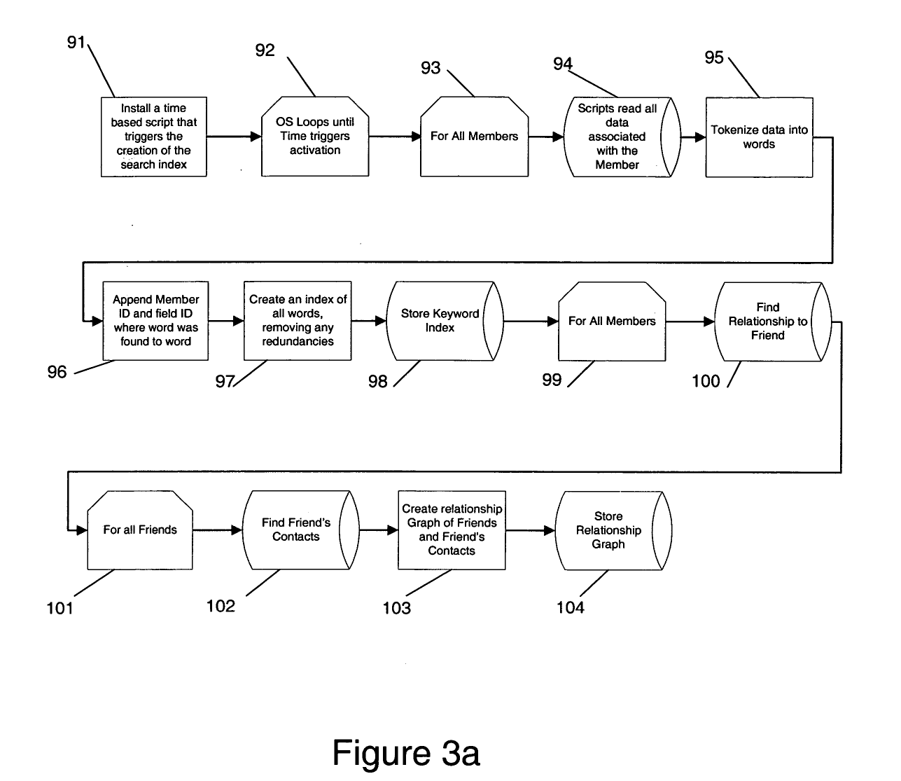

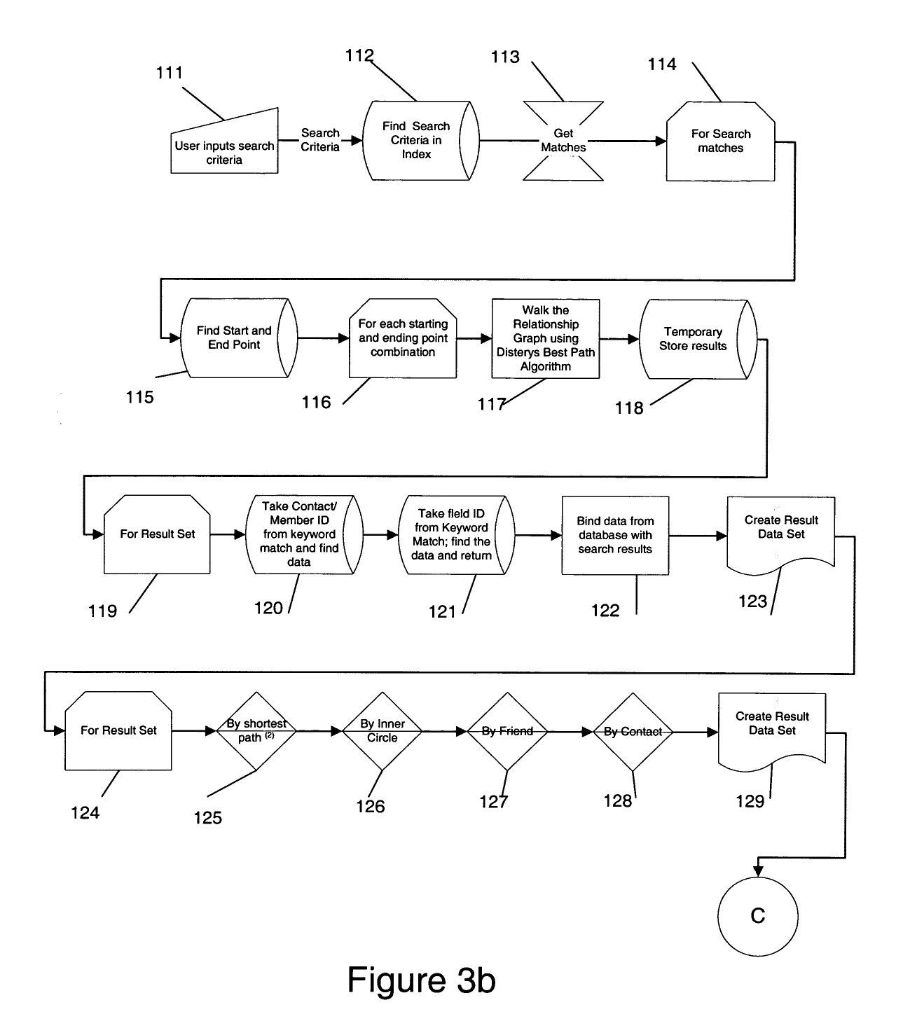

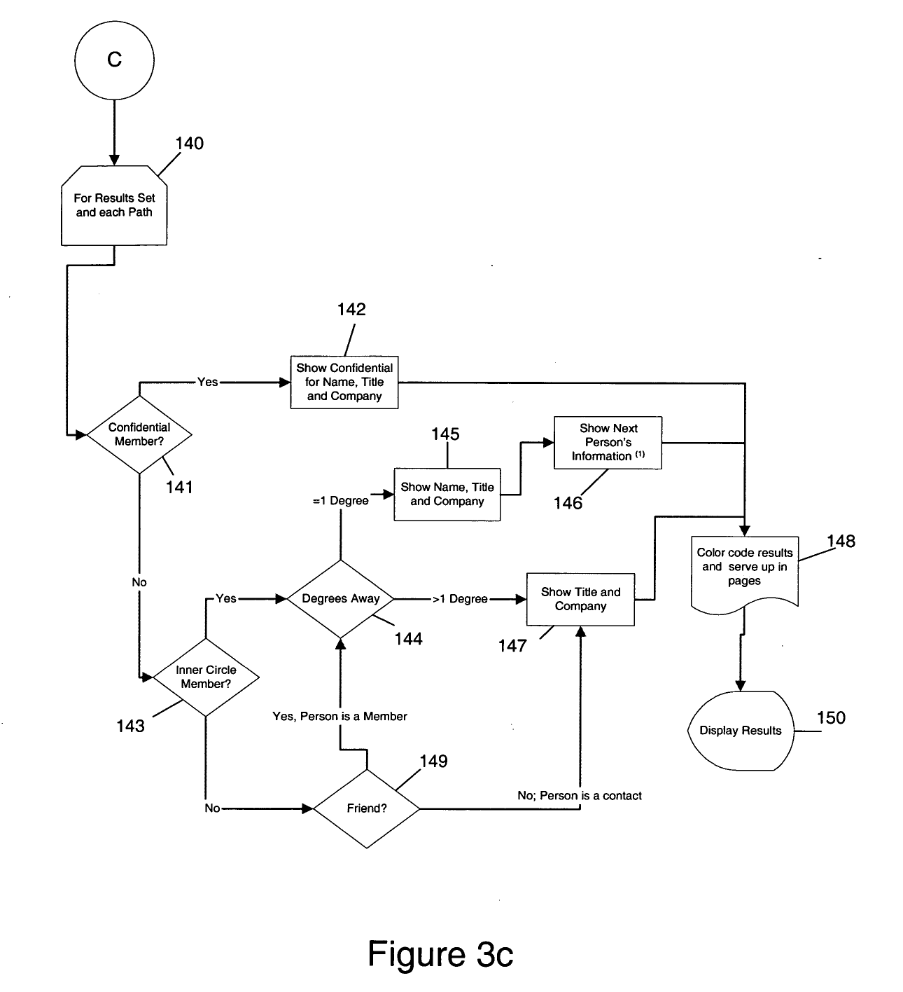

Referring to FIG. 3a, a flow diagram for creating a searchable index and relationship graph is shown according to an embodiment of the present invention. In block 91, a time-based script that triggers the creation of the search index is installed. In other words, it is often undesirable to recreate a search index continuously because doing so takes up processing bandwidth. Accordingly, the time-based script may be used to indicate when a search index should be create (re-created). In block 92, the operating system (OS) loops (i.e., waits) until time triggers activation. Control then passes to block 93, and the program loops through all members of the network. In this example, the network is the universal network kept by the server system. In block 94, the program scripts cause all data associated with the member to be read. Such data could include contact information, business information, personal interests, etc. In block 95, the data read concerning the member is tokenized into words using any of a variety of known methods. Each entry in the index may be associated with a member and may be associated with a field in the data associated with a member. In block 96, the member ID and field ID, where the keyword is found, is appended to the keyword for facilitating the search. In block 97, an index of all keywords is created removing any redundancies. In block 98, the keyword index is then stored for later searching.

In block 99, the program loops for all members to find “friends” (e.g. members who have a certain trust level) in block 100. Then, in block 101 and 102, the program loops through each friend to collect the contacts associated with that friend. In block 103, the relationships between friends and contacts is formed in a relationship graph. In other words, the relationship graph represents the user's relationship to its friends and contacts as well as the contacts of the user's friends. In block 104, the relationship graph is stored.

Referring to FIG. 3b, a flow diagram for performing a general search is shown. In block 111, a user input search criteria for the system. Such search criteria can be a selection of keywords, data fields, etc. In block 112, the search criteria is compared to the index (e.g., generated in block 98 of FIG. 3a). In block 113, the matches with the contacts are collected. In blocks 114 and 115, for each search match, the program loops through finding the start and end points between the user and the matched contact. In blocks 116 and 117, for each starting and ending point combination for the user and matched contact, the program analyzes the relationship graph to map a relationship between the two (e.g., using Dijkstra's Best Path Algorithm which is known in the art for searching network connections). These results are then stored (block 118).

In block 119, the program loops through the results set and for each match, retrieves the contact/member ID (block 120) and the data associated with the contact/member ID is retrieved (block 121). In block 122, the data from the database on the matched contact/member is binded with the search results. A result data set is created (block 123). Then for each result set, the program looks through the matches to rank the results (block 124). In this embodiment, the results are ranked first by shortest path. In other words, if the matching contact is a “friend” of the user, then such a path would be shorter compared to a matching contact that was only a contact of a “friend” of the user. The results can also be ranked by a trust level of the matching contact. In this embodiment, “inner circle” contacts (block 126) are ranked higher than “friend” contacts (block 127) and general contacts (block 128). In block 129, the result data set is created.

Referring to FIG. 3c, the program loops through the result set (block 140) and determines whether the contact is a “confidential” member. In this embodiment, any member may designate themselves as “private” or “confidential,” which prevents their contact information from being displayed as part of the search results. For example, if the contact match is a contact of a user's “friend,” there is a strong likelihood that the user and the matching contact do not personally know each other. Accordingly, the “confidential” designation prevents a member's contact information from being unduly distributed to others without his/her control. If the matching contact is a confidential member, then control passes to block 142 and identification information for the matching contact is not shown (or is replaced by the designation “Confidential”). Then the results are color coded and displayed in pages to the user (see block 148 and 150).

According to one embodiment of the present invention, if the matching contact is not a confidential member (decision block 141), then control passes to block 143 to determine if the relationship path between the matching contact and the user includes an “inner circle” contact. If so, then control passes to decision block 144 to determine the number of degrees between the user and the matched contact (i.e., how many people are between the user and the matched contact in the relationship graph). If there is one degree of separation, then control passes to block 145, and the name, title, and company of the inner circle friend can be displayed as will as the matching contact's information (block 146), and control passes to blocks 148 and 150. If the matching contact is more than 1 degree separated from the user, then only the title and company of the matching contact (block 147) can be displayed.

If there are no inner circle members between the user and the matching contact, then control passes to decision block 149 to determine whether there is a “friend” between the user and the matching contact. If there is, then control passes to decision block 144 to determine the number of degrees between the user and the matching contact, as with the “inner circle” example, in this embodiment, if there is only the “friend” between the matching contact and the user, the contact information for the friend and the contact is shown. If there is no friend in the relationship path between the user and the matching contact, then the matching contact is simply a contact and only the title and company of the matching contact is shown (block 147) in this embodiment.

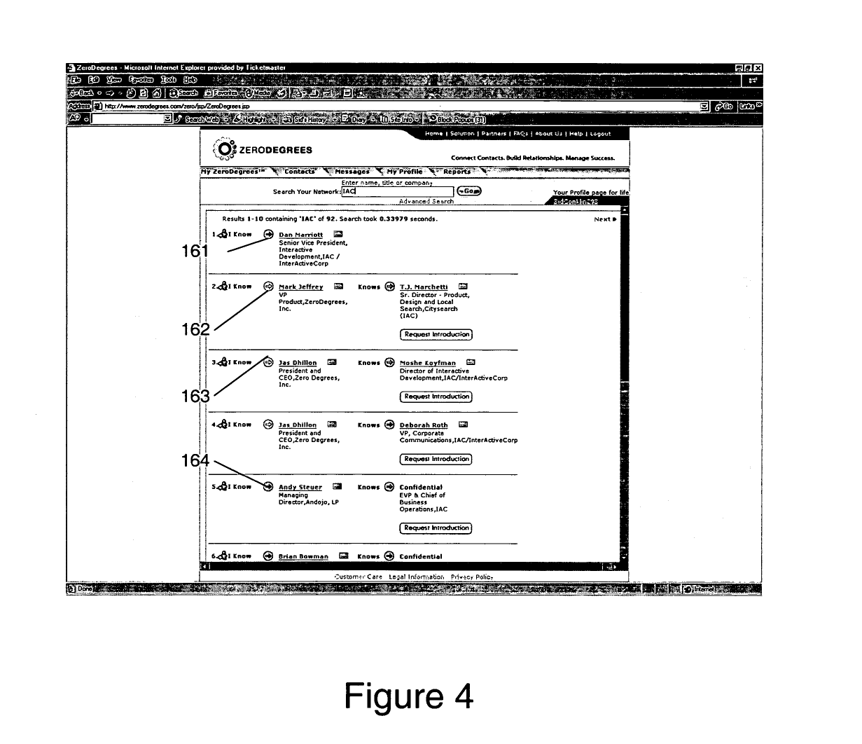

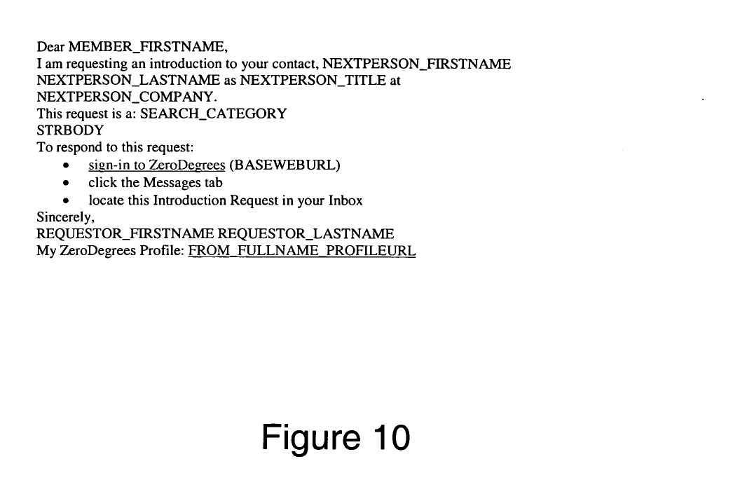

Referring to FIG. 4, an example of a screen display for the search results of FIGS. 3a-c is shown. In FIG. 4, the arrows, e.g., arrows 161-165 may be color coded to indicate the type of relationship between the user and the identified contact. For example, one color would identify “friends” and another would identify contacts. In this embodiment, arrows 161 and 164 point to general contacts and arrows 162 and 163 point to friends. As seen in FIG. 4, the matching contacts are listed in the final column of the display. Since arrow 164 points to a general contact, the matching contact lists “Confidential” because of that member's previous designation. Since arrows 162 and 163 point to “friends,” the contact information for the matching contact is displayed. Though arrow 161 points to a contact, all contact information is given since the contact was provided by the user. As seen in the final column of FIG. 4, a user may select “Request Introduction,” which provides a manner for requesting the intervening contact to introduce the user to the matching contact (e.g., through an E-mail message such as the one shown in FIG. 10).

As discussed above, a trust level may be assigned to each contact in a subscriber's contact list. According to an embodiment of the present invention, the “inner circle” trust level is the highest level that can be assigned to a contact. The inner circle trust level allows subscribers to selectively invite other subscribers to not only search across their contact database but also browse in real time and view detailed contact information on the contacts in their individual databases.

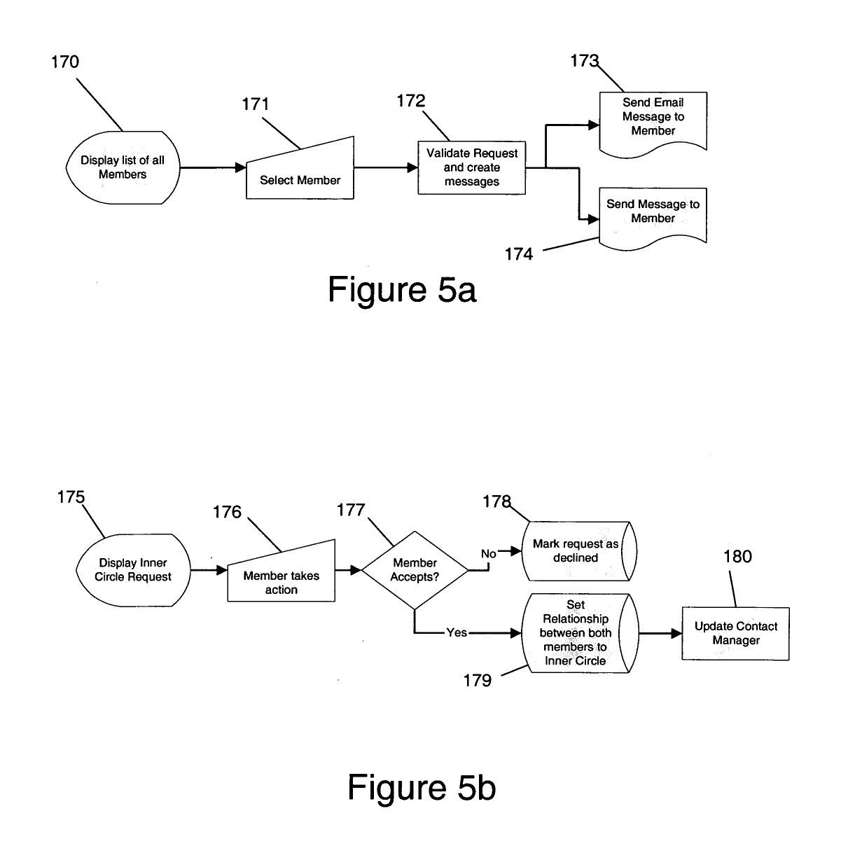

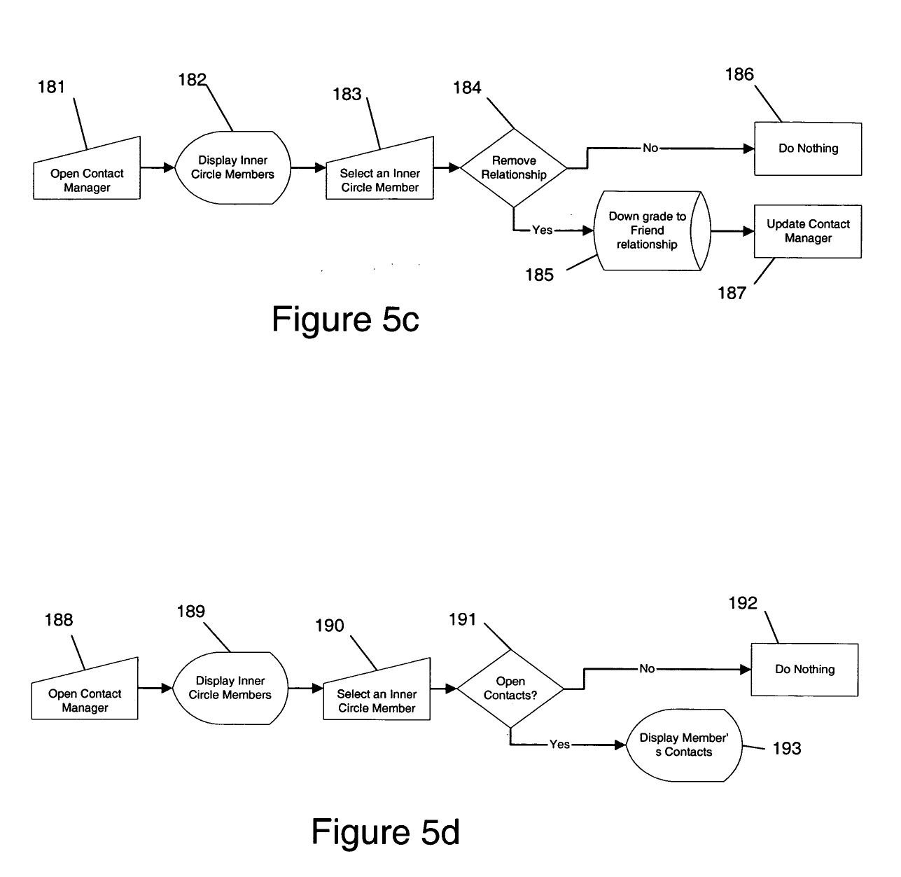

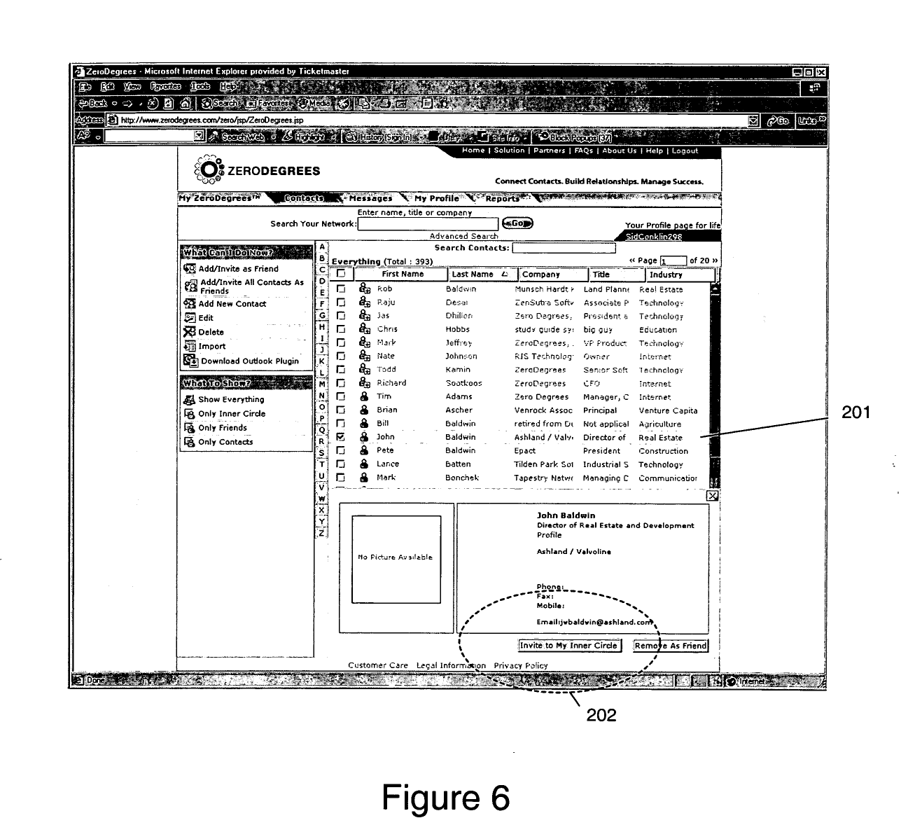

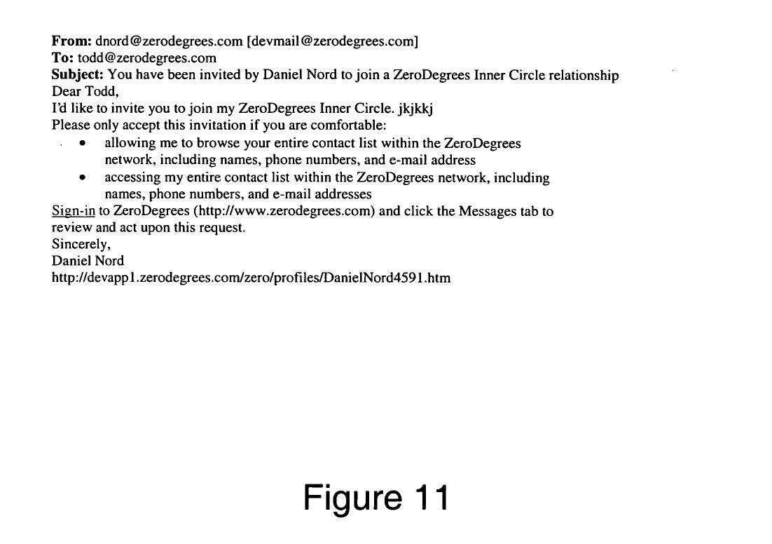

Referring to FIGS. 5a-d, flow diagrams are shown concerning aspects of the inner circle trust level. In FIG. 5a, an example of a method for inviting a member of the network to obtain an inner circle trust level for a subscriber is shown. In block 170, the list of all members is displayed to the subscriber. In block 171, the user/subscriber selects (e.g., with a cursor control device) one of the members to be given a higher trust level. In block 172, the request is validated and in block 173, a message is displayed to the user and in block 174, an E-mail message is sent to the selected member to invite him or her to participate in the higher trust level relationship with the user/subscriber (an example of such an E-mail message is shown in FIG. 11). As seen in FIG. 6, an example of a contact manager user interface is shown. The selected member 201 is highlighted and displayed in a lower window. The user can select “invite to My Inner Circle” 202 to initiate the sending of a invitation message to the selected member.

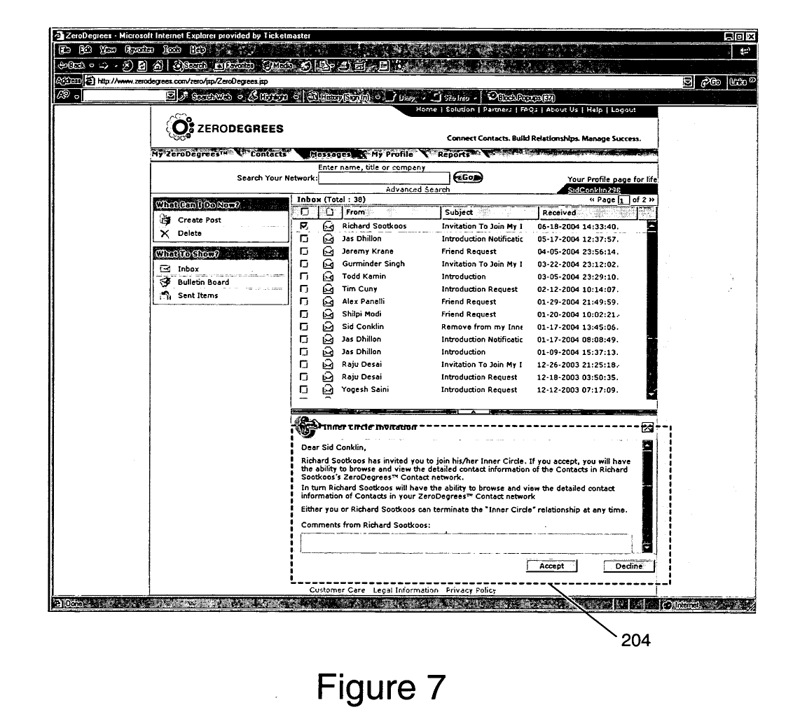

Referring to FIG. 5b, the invitation message is displayed to the selected member (block 175). In block 176, the selected member takes action (inputs acceptance or denial of the request). In decision block 177, if the selected member does not accept the request, then control passes to block 178 where the request is marked as “declined,” and a notification may be sent back to the user/subscriber. In block 179, when the selected member accepts the request, the relationship between the user and the selected member is set at the higher trust level. The contact manager for the user may then be updated (block 180). Referring to FIG. 7, an example of a contact manager user interface for the selected member is shown. The invitation is shown in the lower window 204, and the selected member is allowed to select “accept” or “decline” in this embodiment.

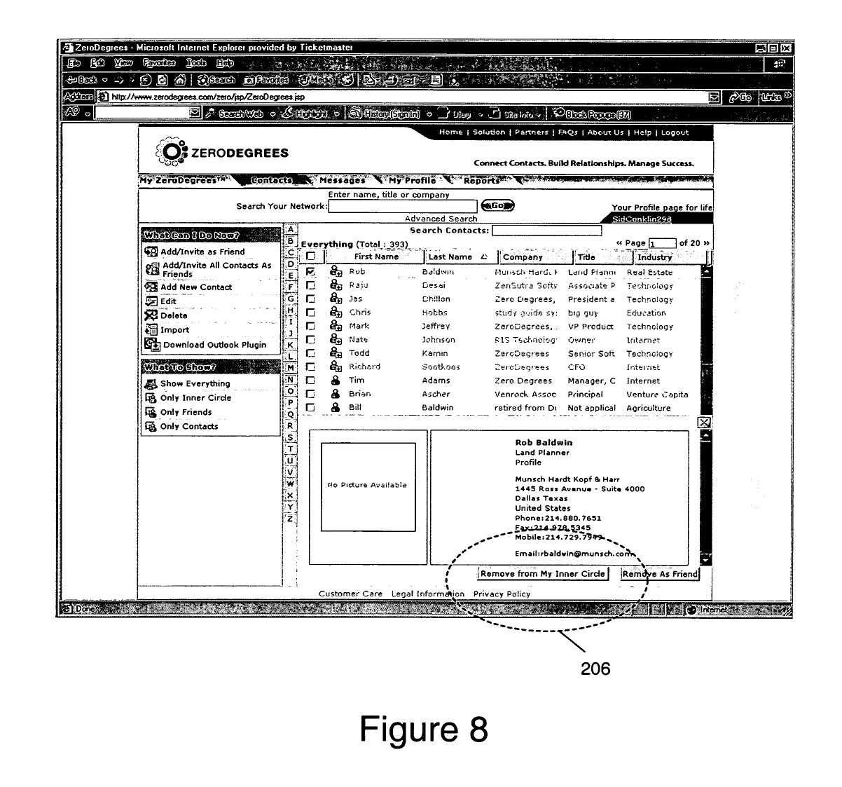

Referring to FIG. 5c, a user is also able to change the trust level for a contact. In block 181, the user opens the contact manager and displays it as in block 182 (see, e.g., FIG. 8). In block 183, the user is able to select an inner circle member from its contact list. If the user desires to change the trust level (or relationship) of the contact (see blocks 184 and 185), he/she may do so (e.g., by selecting the “remove from My Inner Circle” option 206 as shown in FIG. 8). In block 187, the contact manager (and the client's contact database) is updated. The user may also be given the opportunity to downgrade the trust level from friend to contact, or not change the trust level at all (block 186).

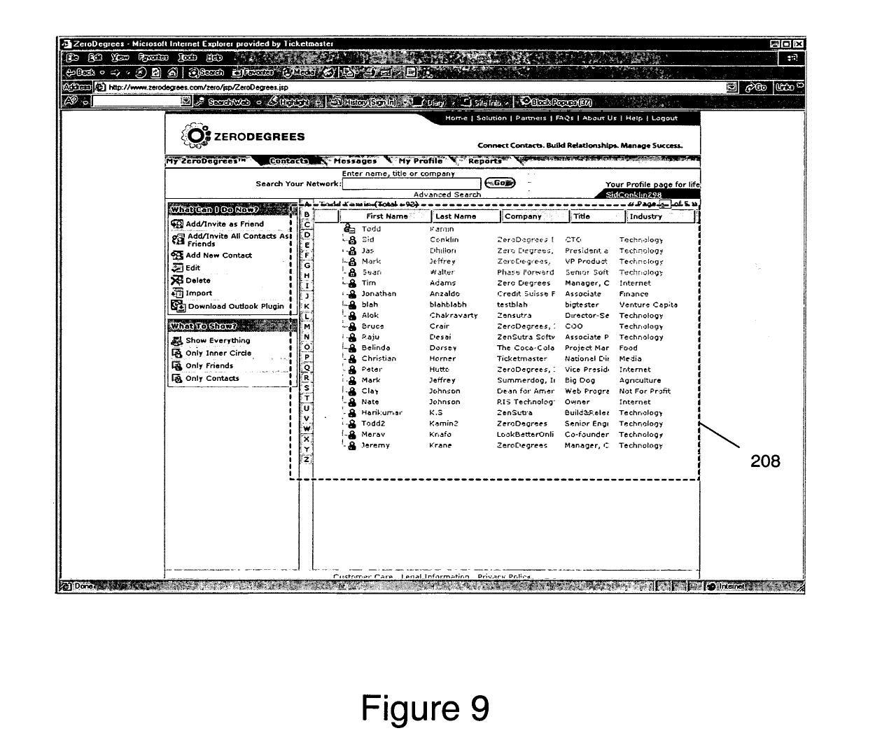

As described above, setting the trust level to a high level (e.g., “inner circle”) allows a user to see more information on the contacts for the member having such a high trust level. In the example of FIG. 5d, a user is able to open and view the contents of another member's contacts if that other member is an inner circle contact. In block 188, the user opens the contact manager and displays the inner circle contacts as in block 189 (see, e.g., FIG. 9). In block 190, the user is able to select an inner circle member (i.e., one where this high trust level has been previously created). The user may desire to open the contacts of the inner circuit member (block 191). In such a case, the contacts, including general contact, friends, and inner circle friends of the selected inner circle member can be displayed to the user (block 193). An example of such a list is shown as element 208 in FIG. 9.

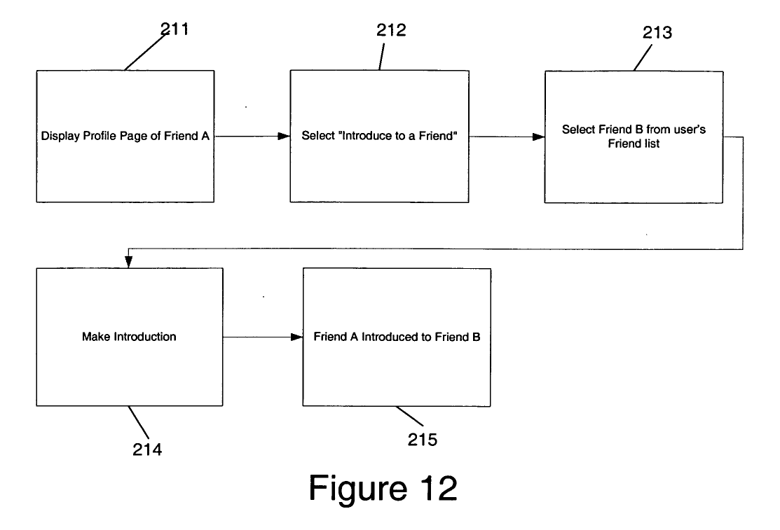

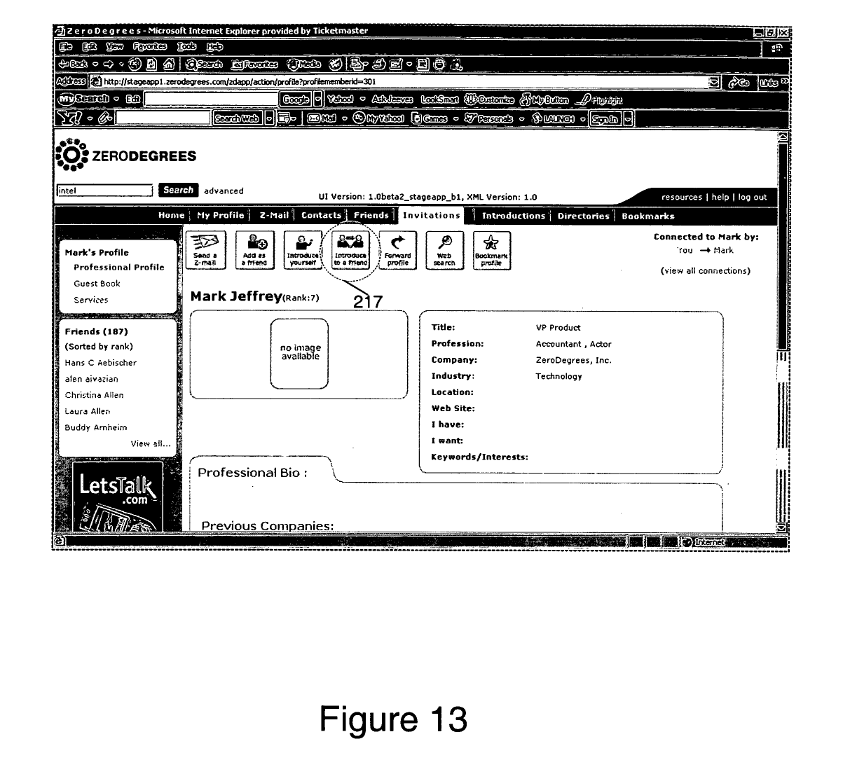

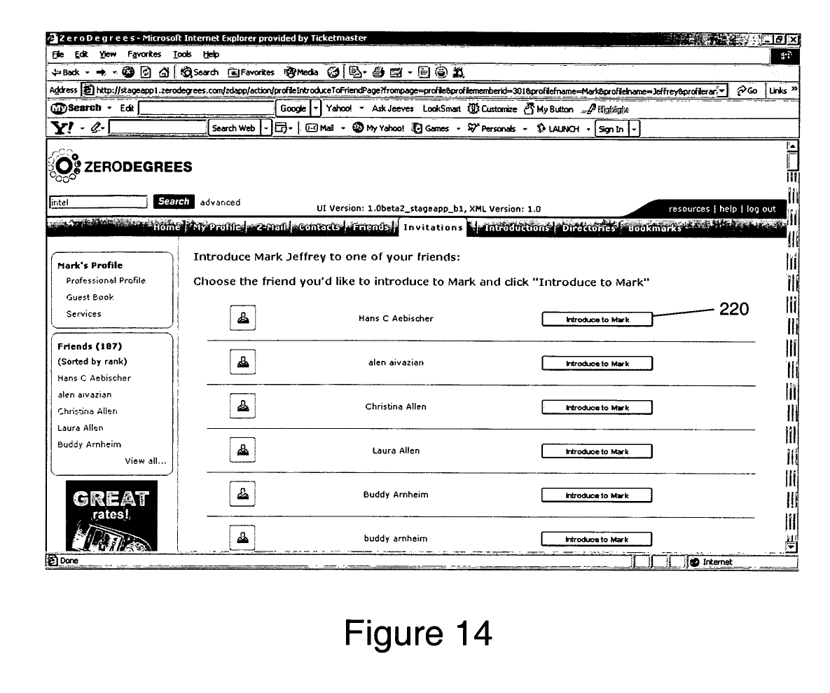

In an alternative embodiment, a user may desire to facilitate introductions between two of the user's friends. Acting as an intermediary, the user may decide that two friends should meet and inform each party of the existence of the other party. Referring to FIG. 12, the user can facilitate introductions between two of the user's friends. In Block 211, the user opens the profile page of Friend A. An example of such a page is shown in FIG. 13. In Block 212, the user may select to introduce Friend A to another friend, as shown by selecting element 217 in FIG. 13. In Block 213, the user is presented with a list of their friends. An example of such a list is shown in FIG. 14. By selecting element 220 in FIG. 14, the user may choose to introduce Friend A to one of the Friends B on the list in FIG. 14. In Blocks 214 and 215, Friend A is introduced to Friend B (for example, by automatically sending E-mail introductions to both individuals).

Alternatively, the user would not be restricted to introducing only friends. The user could introduce one or more contacts without necessarily being friends. This also would provide the contacts another opportunity to be invited to join the network.

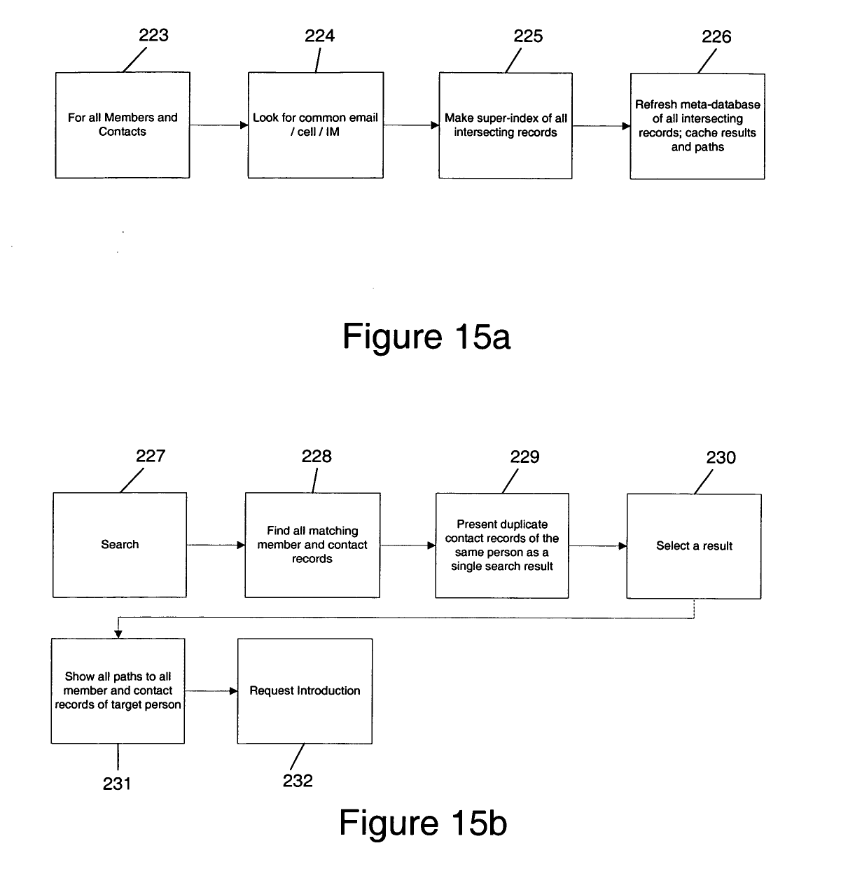

In another embodiment of this invention, the system can routinely check and unify any contacts that refer to the same individual. Referring to FIG. 15a, the system can check each contact and member and look for commonalties such as email addresses, cell phone numbers and instant messaging identifiers (blocks 223 and 224). Through these identifiers, the system will determine if the intersecting contact records represent the same individual. The system then creates a super-index of all these intersecting records (block 225). The system then refreshes the database to incorporate the super-index and caches the results and paths to the contacts (block 226).

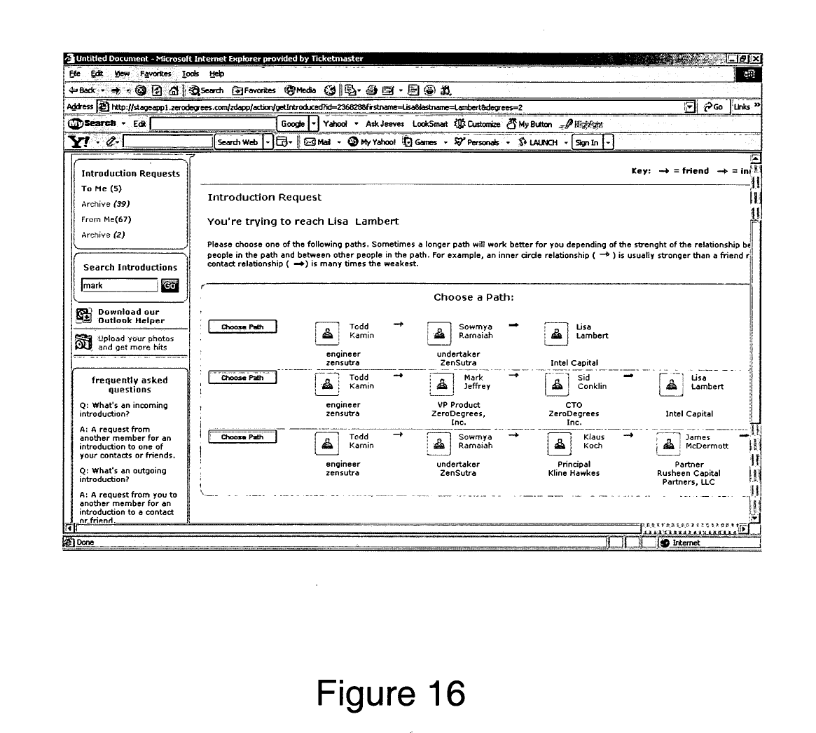

Referring to FIG. 15b, upon searching for a target person (blocks 227 and 228) instead of presenting multiple paths to the same individual, the system will present duplicate contact records as the same person in a single search result (block 229). Upon selection of that search result by the user (block 230), the system will show all the paths and contact records of the target person (block 231). The user may then through any path chosen request an introduction (block 232) as shown in FIG. 16.

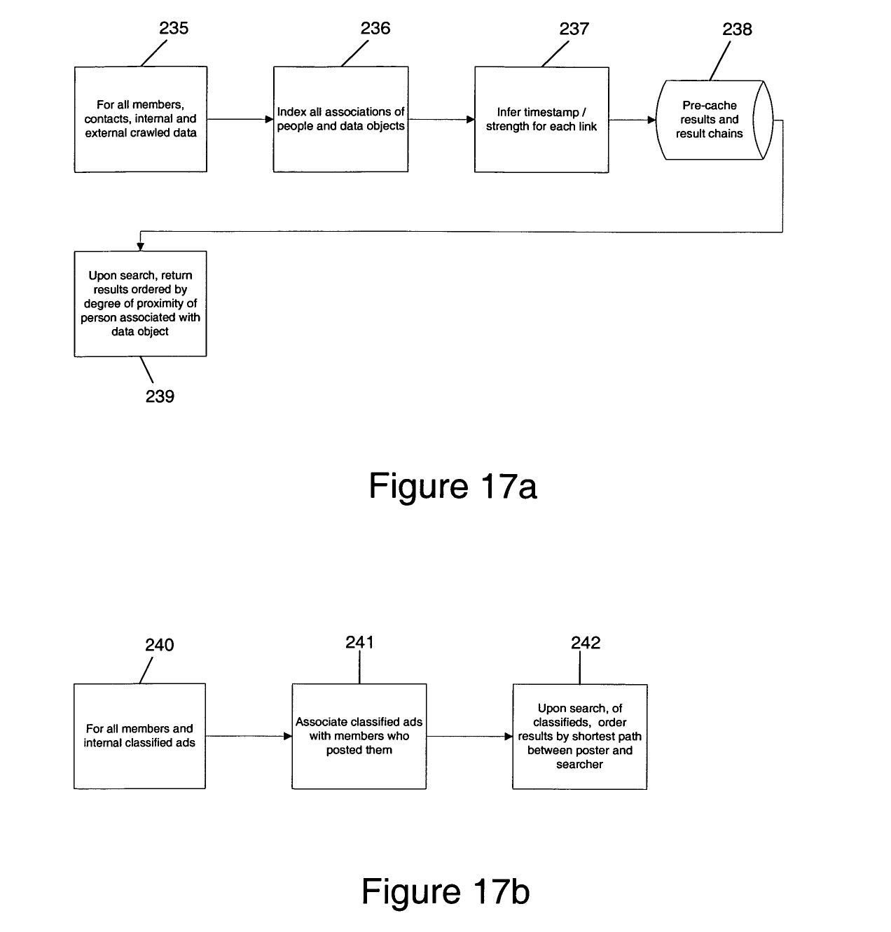

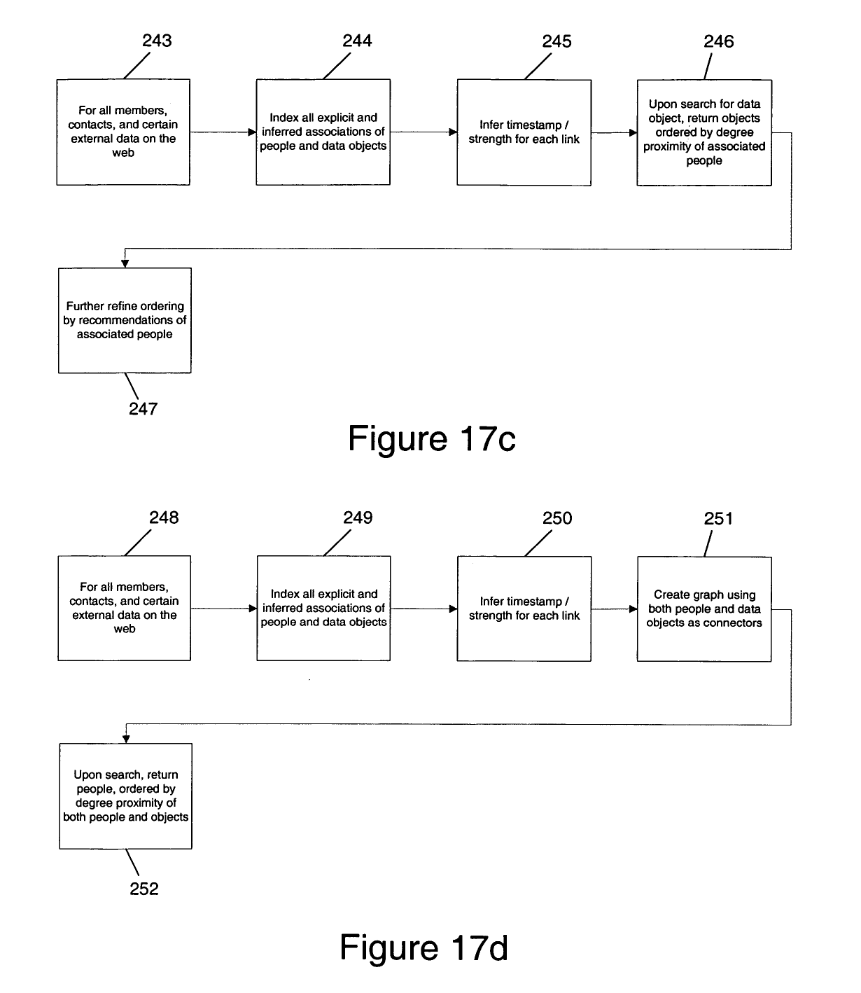

In yet another embodiment of this invention, members and contacts are associated with data objects. As shown in FIG. 17a, for all members and contacts, data objects are searched for both internal to the network and externally (block 235). Several methods exist in the art to discover these data objects, such as crawling the World Wide Web through use of a search engine. Upon finding of the data objects, the system indexes all associations of people and data objects (block 236). Each link in these associations can be evaluated for strength based on the timestamp of the data object (block 237). Other methods of weighing could be used. The system then pre-caches the results and result chains (block 238) and upon searching returns the results ordered by degree of proximity of the person associated with the data object. (Block 239).

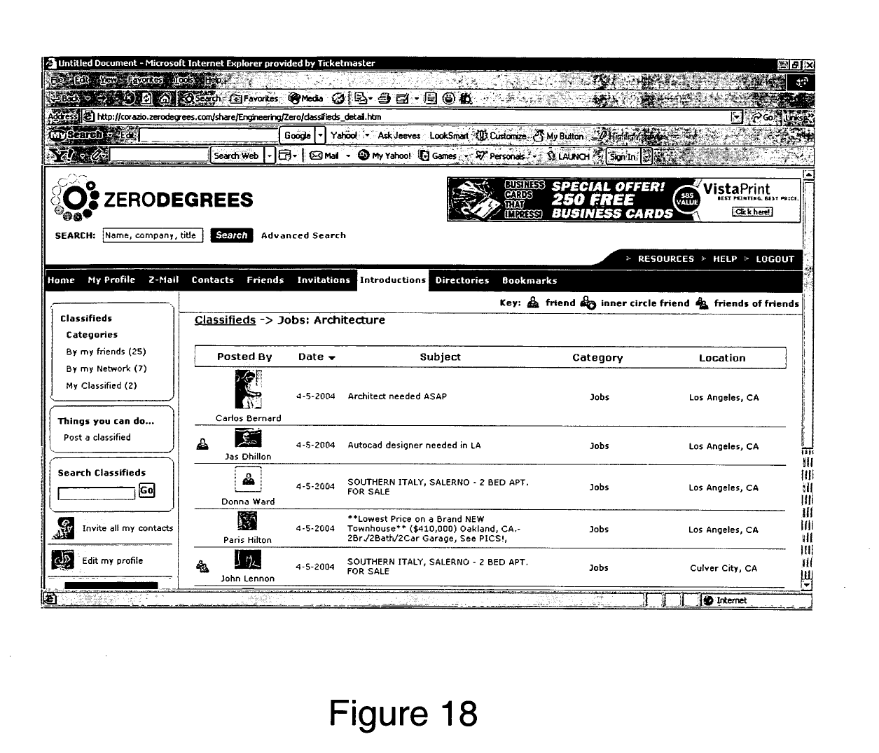

In one example of this association, members are associated with classified ads posted internal to the relational network (FIG. 17b, blocks 240 and 241, FIG. 18). When a user searches the classifieds, the results will be sorted by the shortest relational path between the poster and user (block 242).

In another example, a user may desire to find some data object such as a product to purchase or a hotel to use. As before, for all members and contacts, the system can index all associations of people with data objects (FIG. 17c, blocks 243 and 244). Appropriate strengths are created for each link (block 245). Upon a user's search for the data object, for instance the hotel to use, the results are returned based on degree proximity of associated people (block 246). The system could then optionally further refine the ordering based on the recommendations of the associated people (block 247).

In another example, data objects may connect one individual to another. As before, for all members and contacts, associations of data objects to people are indexed and timestamp evaluated (FIG. 17d. Blocks 248, 249, and 250). The system could then create a graph using both people and data objects as connectors (block 251). Upon searching, results would be returned ordered by degree proximity of both people and objects (block 252). So for example, if a friend of a friend belonged to the same group as the target, then this would be accorded less weight than if the member belonged to the same group as the target.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A method of initiating introductions between a first and second individual comprising:
Providing a database of contact information of individuals including a first and second individual;
In a computer system, selecting said first and second individuals from said database by a first user;
Automatically sending a message to said first and second individuals to facilitate an introduction between said individuals.

2. The method of claim 1, wherein the first and second individuals are contacts to a network, each contact having associated with it relationships to a number of additional contacts.

3. The method of claim 2, wherein the first individual has a relationship to the first user, and the second individual has a relationship to the first user.

4. The method of claim 3, wherein each relationship has a trust level.

5. A method of maintaining a network of contacts wherein the network includes a number of relationships between contacts the method comprising:
Collecting personal information data associated with each of the contacts in said network;
Determining whether multiple contacts in said network represent a single individual;
When said multiple contacts represent the single individual, associating a unique identifier with each of said multiple contacts; and
Creating a relationship graph between each contact in said network based on said associating operation.

6. The method of claim 5, wherein said relationship graph contains relational information between a first and second contact, where the first contact has a relationship to some individual represented by said unique identifier, and where the second contact has a relationship to some individual represented by the same said unique identifier.

7. The method of claim 5, wherein the personal information data is selected from the group consisting of an individual's name, an individual's mailing address, an individual's email address, an individual's telephone number, and an individual's identifier on an instant messaging service.

8. A method of generating a network of contacts comprising:
Collecting personal data associated with each of the contacts in a database; and
Creating a relationship graph between each contact in said database based on similarities of the personal data of each contact.

9. A method of claim 8, further comprising:
providing a weight value for each entry of personal data associated with each of the contacts based on the source of the personal data.

10. A method of claim 8, wherein the collection of personal data comes from searching the contact's entries in the database.

11. A method of claim 8, wherein the collection of personal data comes from searching an electronic medium for contact's personal data.

12. A method of claim 8, wherein a first user related to a first contact, is able to search for personal data associated with said contact.

13. A server system, comprising:
A server to store a database of contact information of individuals including a first and second individuals, selecting said first and second individuals from said database, based on input by a user, automatically sending a message to said first and second individuals to facilitate an introduction between said individuals.

14. A server system, comprising:
A server to store a network of contacts wherein the network includes a number of relationships between contacts, said server collecting personal information data associated with each of the contacts in said network, determining whether multiple contacts in said network represent a single individual, when such a determination is made, associating a unique identifier with each of said multiple contacts, creating a relationship graph between each contact in said network based on said associating operation.

15. A server system, comprising:
A server to store a database of contacts, said server collecting personal data associated with each contact in said database, and creating a relationship graph between each contact in said database based on similarities of the personal data of each contact.

16. The server system of claim 15 wherein said server collects personal data from searching each contact's entries in said database.

17. The server system of claim 15 wherein said server collects personal data from searching an electronic medium for each contact's personal data.

18. A computer system, comprising:
A computer to access a storage of electronic mail messages corresponding to a user and collect a plurality of contacts and data objects associated with said plurality of contacts from said stored electronic mail messages.
